(19) United States
(12) Patent Application Publication
(10) Pub. No.: US 2012/0067228 A1
(43) Pub. Date: Mar. 22, 2012

(54) COLLAPSIBLE GRILL

(76) Inventor: Wayne Hale, Uvalde, TX (US)

(21) Appl. No.: 13/239,094

(22) Filed: Sep. 21, 2011

Related U.S. Application Data
(60) Provisional application No. 61/385,004, filed on Sep. 21, 2010.

(51) Int. Cl. A47J 37/07

(52) U.S. Cl. 99/449

(57) ABSTRACT

A collapsible grill having a pair of long sides, a pair of short sides, and connecting hinges and rod connectors that allow for a cooperative assembly of the collapsible grill having a cooking surface and structure to hold a cook pot.

### CROSS REFERENCE TO RELATED APPLICATIONS

This application claims priority to U.S. Patent Application Ser. No. 61/385,004, which was filed Sep. 21, 2010. This priority application is hereby incorporated by reference in its entirety into the present application, to the extent that it is not inconsistent with the present application.

### FIELD OF THE DISCLOSURE

The present disclosure generally relates to outdoor cooking, and more particularly, to outdoor grills having the ability to be collapsed or otherwise broken down for convenient transportation or travel.

### BACKGROUND

Conventional grills come in various shapes and sizes, and are generally configured for back porch-type operation, i.e., stand-alone operation in the same location without travel or transport. However, conventional grills are also often used in remote locations, such as tailgate parties at sporting events, camping or hiking, cooking in parks, etc., and the grill industry has accommodated this need with a number of downsized or small grills that are essentially portable. The smaller portable grills, however, are notoriously weak or flimsy and generally do not provide enough cooking surface area to accommodate more than just a few people.

Therefore, there is a need for an improved portable grill that provides increased cooking surface area, starting, and yet still maintains the ability to be easily portable.

### SUMMARY

Embodiments of the disclosure may generally provide a portable grill manufactured from sturdy metal that provides a large cooking surface capable of feeding 10 or more people, while still being portable. The grill proposed in the following embodiments may generally be disassembled or folded it into a few parts that are able to be integrally transported.

### BRIEF DESCRIPTION OF THE DRAWINGS

The present disclosure is best understood from the following detailed description when read with the accompanying Figures. It is emphasized that, in accordance with the standard practice in the industry, various features are not drawn to scale. In fact, the dimensions of the various features may be arbitrarily increased or reduced for clarity of discussion.

FIGS. 1a and 1b illustrate opposing side views (inside and outside) of the short side of an exemplary grill of the disclosure.

FIGS. 2a and 2b illustrate opposing side views (inside and outside0 of the long side of an exemplary grill of the disclosure.

FIG. 3 illustrates a top view of an exemplary grate that may be positioned on top of an exemplary grill of the disclosure to cook food thereon.

FIG. 4 illustrates a partially assembled view of an exemplary grill of the disclosure on the hinge side.

FIG. 5 illustrates a partially assembled view of an exemplary grill of the disclosure on the non-hinge side.

FIG. 6 illustrates a top view of an assembled grill of the disclosure, without the top grate member of thereon.

FIG. 7 illustrates an exemplary hinge of the disclosure, having a heat protecting element.

FIG. 8 illustrates four sides of the exemplary grill of the disclosure in a disassembled form.

FIG. 9 illustrates an alternative embodiment of the exemplary grill and a disassembled form.

FIG. 10 illustrates another alternative embodiment of the exemplary grill where the grill is compacted, without disassembly.

### DETAILED DESCRIPTION

It is to be understood that the following disclosure describes several exemplary embodiments for implementing different features, structures, or functions of the disclosure. Exemplary embodiments of components, arrangements, and configurations are described below to simplify the present disclosure; however, these exemplary embodiments are provided merely as examples and are not intended to limit the scope of the disclosure. Additionally, the present disclosure may repeat reference numerals and/or letters in the various exemplary embodiments and across the Figures provided herein. This repetition is for the purpose of simplicity and clarity and does not in itself dictate a relationship between the various exemplary embodiments and/or configurations discussed in the various Figures. Moreover, the formation of a first feature over or on a second feature in the description that follows may include embodiments in which the first and second features are formed in direct contact, and may also include embodiments in which additional features may be formed interposing the first and second features, such that the first and second features may not be in direct contact. Finally, the exemplary embodiments presented below may be combined in any combination of ways, i.e., any element from one exemplary embodiment may be used in any other exemplary embodiment, without departing from the scope of the disclosure.

Additionally, certain terms are used throughout the following description and claims to refer to particular components. As one skilled in the art will appreciate, various entities may refer to the same component by different names, and as such, the naming convention for the elements described herein is not intended to limit the scope of the disclosure, unless otherwise specifically defined herein. Further, the naming convention used herein is not intended to distinguish between components that differ in name but not function. Additionally, in the following discussion and in the claims, the terms “including” and “comprising” are used in an open-ended fashion, and thus should be interpreted to mean “including, but not limited to.” All numerical values in this disclosure may be exact or approximate values unless otherwise specifically stated. Accordingly, various embodiments of the disclosure may deviate from the numbers, values, and ranges disclosed herein without departing from the intended scope. Furthermore, as it is used in the claims or specification, the term “or” is intended to encompass both exclusive and inclusive cases, i.e., “A or B” is intended to be synonymous with “at least one of A and B,” unless otherwise expressly specified herein.

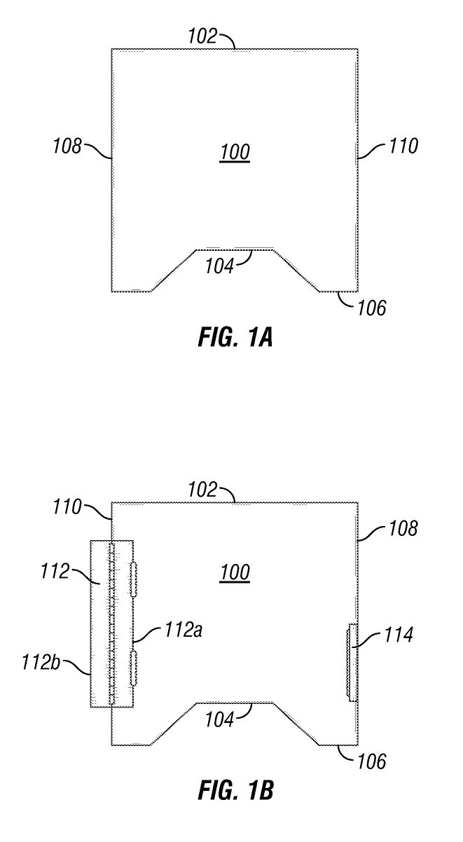

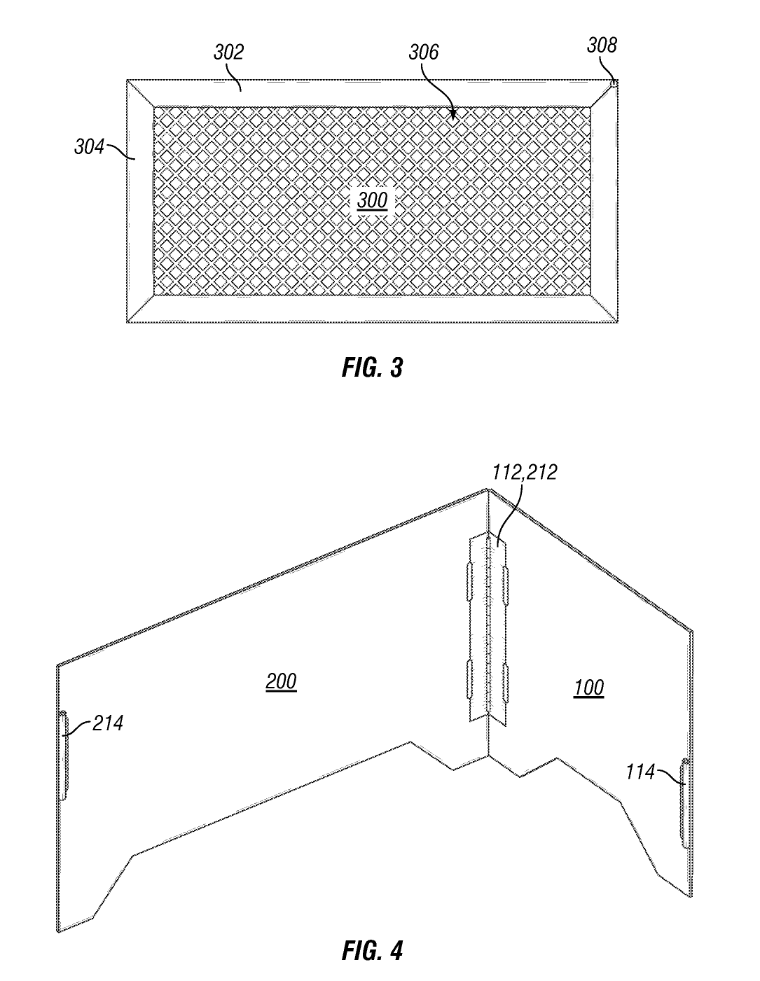

FIGS. 1a and 1b illustrate opposing side views (inside and outside) of the short side of an exemplary grill 001 of the disclosure. They grill 001 generally includes four sides, which in the present exemplary embodiment form a rectangle when looked at in plan. As such, the grill 001 includes two long sides 200 connected by two shorter sides 100 to form a rectangular support member for a grilling surface, which will be further described with regard to FIG. 3.

FIG. 1a illustrates a side view (from the outside) of the short side 100. The short side 100 generally includes a top 102, opposing upright or upstanding sides 108, 110, and a bottom 104. The bottom 104 generally includes leg members 106 that extend downward beyond the bottom portion 104 of the short side member 100. Thus, when looked at from the side, a combination of legs 106 and bottom 104 form an area for air to travel to the lower surface of the assembled grill 001 where the fire or charcoal will be positioned.

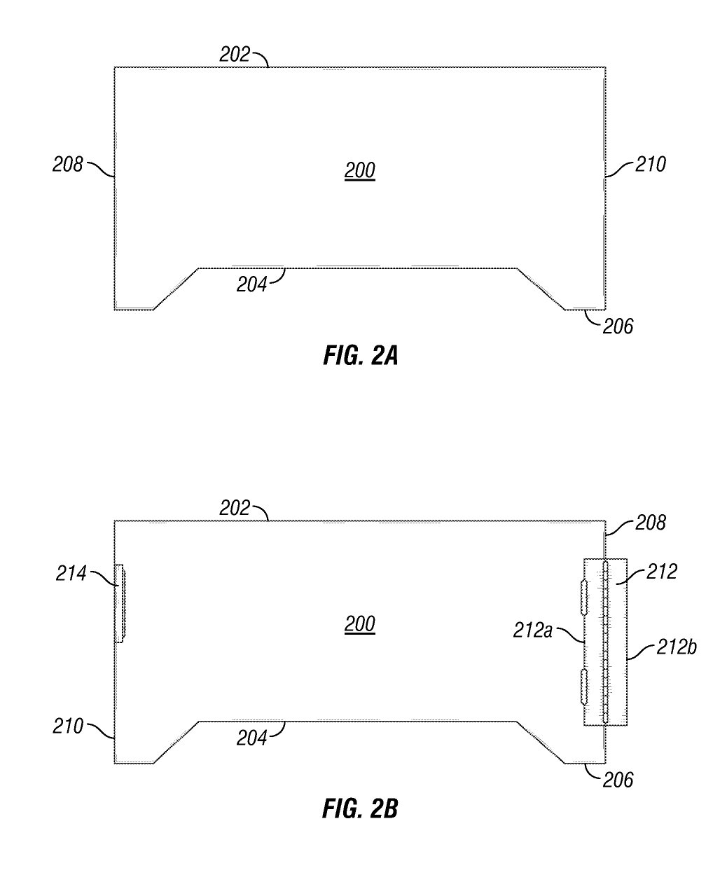

FIG. 2 illustrates a side in the new (from the outside) of the long side 200. The long side 200 generally includes a top 202, opposing upright or upstanding sides 208, 212, and a bottom 204. Again, much like the short side 100, the long side 200 also includes legs 206 that extend down below the bottom 204 to form an area for air to travel to the underside of the grill 001.

FIG. 1b illustrates a side view (from the inside) of the short side 100. With reference to the figure, the left side 110 of the short side 100 has a hinged 112 secured thereto. The hinge 112 may be welded, bolted, screwed, fastened, or otherwise attached to the short side 100. The right side 108 of the short side 100 includes a hollow tubular 114 secured thereto. Again, the tubular 114 may be welded, bolted, screwed, fastened, or otherwise attached or secured to the short side 100. The tubular 114 is generally attached to the lower half of the right side 108 of the short side 100. Further, the tubular 114 generally includes a hollow interior portion extending there through, such that a cylindrical rod may be received therein.

FIG. 2b illustrates a side view (from the inside) of the long side 200. With reference to the figure, the left side 210 of the long side 200 generally includes a tubular 214 secured thereto. The tubular 214 is generally secured (as defined above) to the upper half of the left side 210 of the long side member 200, and includes a hollow interior portion extending there through, such that a cylindrical rod may be received therein/there through. The right side 208 of the long side 200 generally includes a hinge 212 secured (as defined above) thereto.

FIG. 4 illustrates a partially assembled view of an exemplary grill of the disclosure on the hinge side. More particularly, FIG. 4 shows any alongside 200 attached to the short side 100 via hinge 112, 212. As such, FIG. 4 illustrates half of the supporting frame or body for the grill 001, i.e., a short side 108 long side 200 hinged together form and L-shape that can be attached to another pair of hinged members to form a rectangular grill support or body.

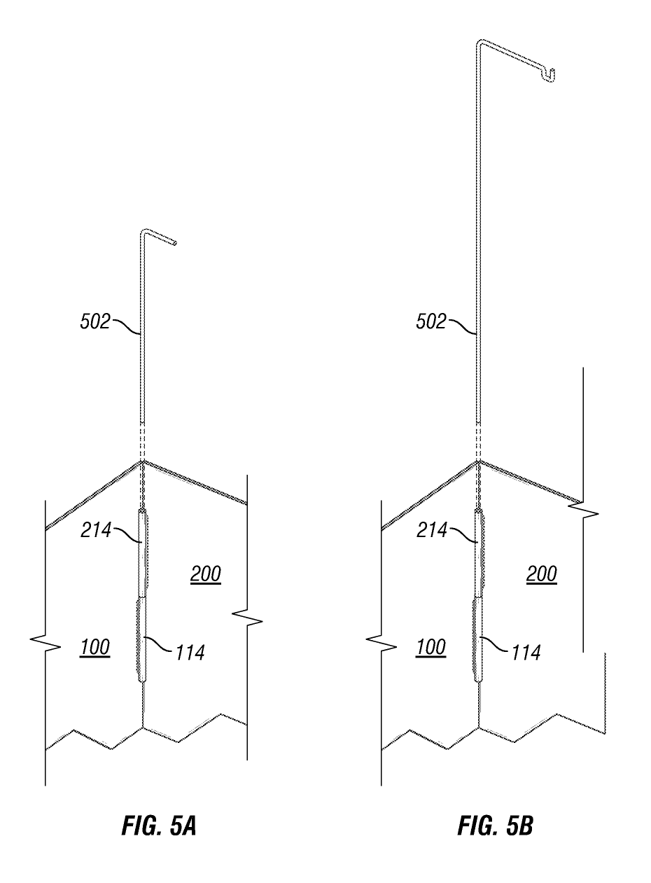

FIG. 5 illustrates a partially assembled view of an exemplary grill of the disclosure on the non-hinge side. With reference to FIG. 4, FIG. 5 illustrates how the non-connected ends shown in FIG. 4 are connected together to form a rectangular body of the grill. More particularly, FIG. 5 illustrates how the tubulars 114, 214 are aligned once the non-connected ends shown in FIG. 4 are brought together. Specifically, as described above, the tubular 214 of the long side 200 is attached to the upper half of the long side 200, while the tubular 114 of the short side 100 is attached to the lower half of the short side 100. As such, when the non-connected in as of the short side 100 in the long side 200 are brought together, the tubulars 114, 214 become aligned. As such, to secure the short side 100 to the long site 200, a connecting pin or rod (not shown) is inserted into the hollow interior portion of the tubular 114, 214.

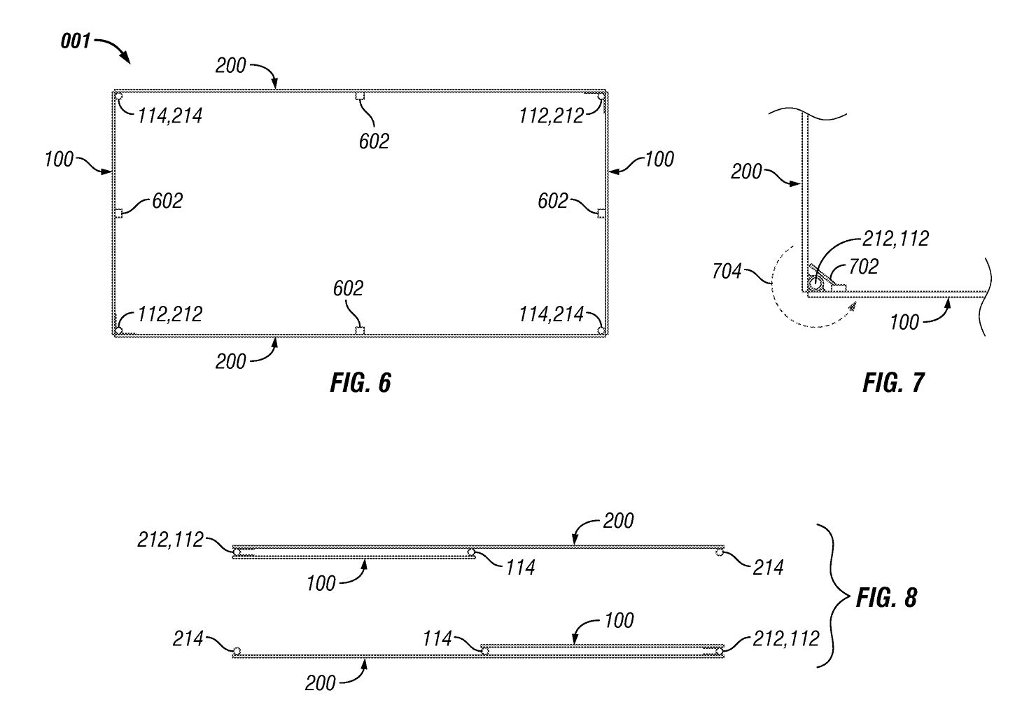

FIG. 6 illustrates a top view of an assembled grill 001 of the disclosure, without the top grate member (described in FIG. 3 below) thereon. The assembled grill 001 generally includes four sides, two long sides 200 and two short sides 100 secured together in a rectangular shape. The four corners are secured together via a two hinges 112, 212 and two sets of tubulars 114, 214 having securing pins or rods position in the hollow portions of the tubular 114, 214. FIG. 6 also illustrates 4 support tabs 602 positioned around the interior perimeter of the grill 001. These tabs 602 may be used to support a fire pan (not shown), which may be a substantially rectangular pan shaped member configured to hold burning charcoal or wood therein. The fire pan would obviously have rounded or removed corners to allow clearance for the hinges 112, 212 or tubulars 114, 214. Additionally, although only 4 tabs 602 are shown, any number of tags may be used, as required to support the fire pan.

FIG. 3 illustrates a top view of an exemplary grate that may be positioned on top of an exemplary grill of the disclosure to cook food thereon. The grate 300 is generally formed an angle or L shaped mental or iron. Further, the grate 300 is generally sized to fit over the top of the assembled grill 001, as shown in FIG. 6. More particularly, the angle iron used to form the perimeter of the grate 311 includes a downwardly projecting portion that is sized to be slightly larger than the exterior perimeter of the assembled grill 001 shown in FIG. 6, thus allowing the grate 300 to fit right over the top of the assembled grill 001. The grate 300 includes a long side 302 that may generally correspond to the long side 200 in overall length, and a short side 304 which may generally correspond with the short side 100 and overall length. The interior portion of the grate 300 generally includes a cooking surface 306, which may be a mental mesh configured to both support food while allowing heat to transmit their through from a fire below. The grate 300 may also include a hole 308 formed through the angle iron in one corner. The whole 308 may be configured to receive a pin or connecting rod 502 there through, where the rod 502 is configured to also be received through the tubulars 114, 214. In at least one exemplary embodiment, the connecting rod 502 may serve a dual purpose, and that the connecting rod may be configured to extend well above the upper grill surface 300 in an L-shaped configuration, which may then be used to support a pot or other cooking utensil above the grilling surface 300.

FIG. 7 illustrates an exemplary hinge of the disclosure, having a heat protecting element. The heat protecting element may generally include a piece of metal secured to one side of the grill 001, wherein the piece of metal 702 extends at angle (about 45°) toward and over the hint element 112, 212. Thus, the metal 702 may operate to prevent the heat and carbon deposits from the grill from forming on or in the hinge element 112, 212, thus fowling the operation of the hinge.

FIG. 8 illustrates four sides of the exemplary grill of the disclosure in a disassembled form. In the disassembled form, guides for body on the grill are generally in two pieces: 1) Two sides (one long side hinged to one short side); and 2) Two other sides (one long side hinged to one short side). These two hinged elements may be secured together for carrying and or transportation. To secure the respective elements together, clasps, clamps, tabs, cords, etc. may be used, as is known in the art. Additionally, the top grate member 300 may also be secured to the side or body members for carrying via clients, clasps, tabs, or other means of securing metal together temporarily. As such, all four sides and the top portion may be secured together for unitary transport or travel.

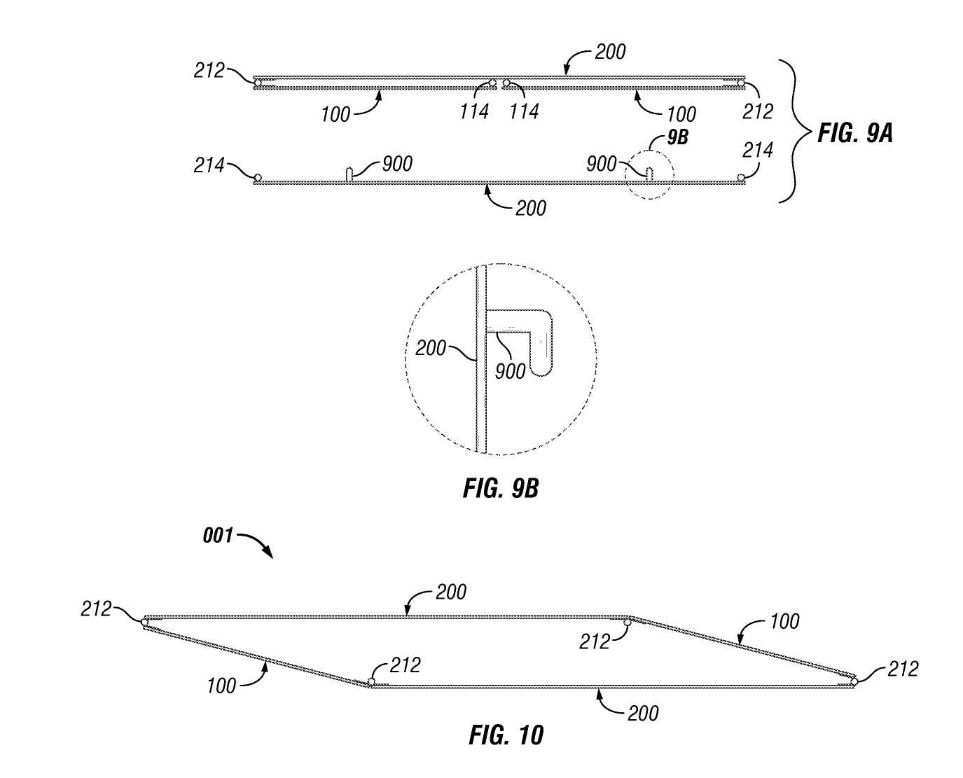

FIG. 9 illustrates an alternative embodiment of the exemplary grill and a disassembled form. In this embodiment, to short sides 100 are hinged 212 to one long side 200. Thus, the disassembly process generally involves removing or detaching one long side 200, and folding the two short sides 100 onto the other long side 200. Then the disassembled alongside 200 may be secured to the folded down other three sides via a tab, hook, clan, or other means of securing metal to metal for travel and/or transportation, as generally denoted by number 900 in FIG. 9. For example, a call out window in FIG. 9 illustrates that the free long side 200 may include an L-shaped bracket 900 extending there from. The L-shaped bracket 900 may be positioned near the top of the free long side 200, such that the bracket 900 may be used to essentially hook the free long side 200 to the folded down other three sides for transport. In this and other embodiments described herein, handles may be formed or otherwise attached to various portions of the side members 100, 200, such that once the side members are folded down and secured together, they may be picked up and easily moved or transported by one or more people.

FIG. 10 illustrates another alternative embodiment of the exemplary grill where the grill is compacted, without disassembly. In this embodiment, all four corners of the exemplary grill 001 may have hinges secured thereto. Therefore, with hinges on all four corners, a disassembly process merely includes removing the top grate 300 and folding the four sides flat. Assembly would be just the opposite.

In an exemplary embodiment of the disclosure, the long side and the short side noted in the embodiments above may be approximately the same length, thus forming a substantially square portable grill.

In yet another embodiment of the disclosure, each of the sides of the portable grill described in the disclosure may be manufactured from plate steel having a thickness of between about ⅛ inch to about ⅜ inch. Additionally, the angle iron used to manufacture the grill top or grate 300 may be about ⅛ to ⅜ inches thick and have a side width of about 1-3 inches.

In another embodiment of the disclosure, a portable grill is provided. The grill may generally include a pair of long sides formed or otherwise cut from sheet steel, the long sides each having two integral legs formed thereon. The term “long” is generally intended to represent the horizontal length of a side panel of the grill, and is generally applicable to embodiments where the grill is rectangle shaped (top view). However, in embodiments where the grill is square, the long side will have essentially the same length as short side (discussed next). The grill also includes a pair of short sides generally formed or otherwise cut from sheet steel, the short sides each having two integral legs formed thereon. The term “short” is generally intended to represent the horizontal length of a side panel of the grill, a side that is shorter than the aforementioned long side, and is generally applicable to embodiments where the grill is rectangle shaped (top view). Embodiments of the disclosure also include a first connecting hinge secured to a pivot end of one of the long sides and a pivot end of one of the short sides, a second connecting hinge secured to a pivot end of another one of the long sides and a pivot end of another one of the short sides, and a first pair of rod connectors secured to a rod connecting end of one of the long sides and a rod connecting end of one of the short sides. The embodiment may further include a second pair of rod connectors secured to a rod connecting end of another one of the long sides and a rod connecting end of another one of the short sides, and a grill top comprising an angle iron formed into a shape of the grill and configured to be received over a top of the grill, wherein the first and second pairs of rod connecting members are configured to be joined together and to receive a connecting rod therein to secure the pair of long sides and the pair of short sides into an integral grill with the grill top received thereon.

The foregoing has outlined features of several embodiments so that those skilled in the art may better understand the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions and alterations herein without departing from the spirit and scope of the present disclosure.

I claim:

1. A portable grill, comprising:
a pair of long sides formed from sheet steel, the long sides each having two integral legs formed thereon;
a pair of short sides formed from sheet steel, the short sides each having two integral legs formed thereon;
a first connecting hinge secured to a pivot end of one of the long sides and a pivot end of one of the short sides;
a second connecting hinge secured to a pivot end of another one of the long sides and a pivot end of another one of the short sides;
a first pair of rod connectors secured to a rod connecting end of one of the long sides and a rod connecting end of one of the short sides;
a second pair of rod connectors secured to a rod connecting end of another one of the long sides and a rod connecting end of another one of the short sides; and
a grill top comprising an angle iron formed into a shape of the grill and configured to be received over a top of the grill,
wherein the first and second pairs of rod connecting members are configured to be joined together and to receive a connecting rod therein to secure the pair of long sides and the pair of short sides into an integral grill with the grill top received thereon.
